(19) United States
(12) Patent Application Publication
(10) Pub. No.: US 2014/0199465 A1
(43) Pub. Date: Jul. 17, 2014

(54) INJECTABLE LOW TEMPERATURE LIQUID CROP PRESERVATIVE FORMULATION

(71) Applicant: 1, 4 GROUP, INC., Meridian, ID (US)

(72) Inventors: John M. Forsythe, Nampa, ID (US); Curtis Lee Eames, Meridian, ID (US); Jan W. De Weerd, Meridian, ID (US); James Zalewski, Boise, ID (US)

(73) Assignee: 1, 4 GROUP, INC., Meridian, ID (US)

(21) Appl. No.: 13/743,236

(22) Filed: Jan. 16, 2013

(51) Int. Cl. A23B 7/154

(52) U.S. Cl. CPC A23B 7/154
USPC 426/654

(57) ABSTRACT

A liquid crop-preservative composition containing a volatile, liquid active ingredient suitable for effective crop-preservation in the vapor-phase. The crop-preservative composition is sufficiently non-viscous to be applied to crops or to a surface disassociated with said crops via one or more minute orifices. A suitable compatible lubricant and diluent may be incorporated in said composition.

### CROSS-REFERENCE TO RELATED APPLICATIONS

This application is related to a Non-provisional Patent application(s) being filed concurrently herewith U.S. application Ser. No. ______ (Attorney Docket No. 1957-8886US) entitled “APPARATUS AND PROCESS FOR LOW-TEMPERATURE INJECTION OF A LIQUID CROP PRESERVATIVE FORMULATION,” and U.S. application Ser. No. ______ (Attorney Docket No. 1957-10340US) entitled: “FRUIT SHELF-LIFE EXTENSION.”

### FIELD OF THE INVENTION

Particular embodiments relate to volatile formulations of crop preservatives such as sprout inhibitors and/or dormancy enhancers and the like for use in processes and apparatus for indirectly treating crops, such as tubers, with vapors from such volatile formulations. Volatile formulations can be used in apparatus and methods for treating crops after storage to preserve same during shipment to warehouses, grocery stores, and the like, especially in small containers such as cardboard boxes, bags and the like.

### BACKGROUND OF THE INVENTION

Tubers, especially potatoes, are treated with sprout inhibitors during storage (See U.S. Pat. No. 6,010,728). These techniques involve placing upon the potato a residue of a sprout inhibitor, especially CIPC, as a dormancy enhancer, 1,4 dimethyl naphthalene (1,4 DMN). Currently, potatoes removed from storage are treated directly with a sprout inhibitor such as a water-based formulation of CIPC (chloroisopropyl carbamate). Alternatively, aerosol containers filled with 1,4 DMN are placed in trucks to provide an enveloping vapor of DMN during shipment to a store or other destination. Duncan and Beveridge in about 1978 treated potatoes with vapors of 1,4 DMN at high dosage levels.

### BRIEF SUMMARY OF THE INVENTION

Liquid chemical crop-preservative compositions suitable for sprout inhibition of ware potatoes in a box, bag or other small shipping containers may comprise 1,4 DMN (1,4 dimethyl naphthalene), in conjunction with suitable adjuvants, diluents, solvents, surfactants, lubricants, odorants or deodorants, or the like. Other suitable volatile chemical preservatives capable of effecting a crop-preservative effect by vapors from such chemicals are useful as well. Other types of preservatives may include volatile fungicides, biocides and pesticides and the like.

In co-pending application, APPARATUS AND PROCESS FOR LOW-TEMPERATURE INJECTION OF A LIQUID CROP PRESERVATIVE FORMULATION, application Ser. No. ______, (Attorney Docket No. 1957-8886US) filed contemporaneously herewith, there is disclosed and claimed an apparatus and method for applying, preferably by injection, a volatile liquid chemical sprout inhibitor composition to boxes, bags or other similar containers to be filled directly or indirectly with ware potatoes.

The liquid chemical compositions disclosed and claimed herein may preferably be applied in accordance with the invention disclosed in said co-pending application, but also by alternative techniques.

It is well known in the art that 1,4 DMN is especially suitable as a dormancy enhancer for potatoes in storage or during shipment. A pure 1,4 DMN product known as 1,4 Sight®, is available from 1,4 Group of Meridian, Idaho. An aerosol container, 1,4 Ship™, filled with 1,4 DMN and a suitable aerosol propellant is also available from 1,4 Group for use in railroad cars, trucks, etc. during shipment of potatoes. Given that 1,4 DMN maintains or returns potatoes to a state of dormancy, it is by such an effect, an effective sprout inhibitor and reducer of respiration. Such aerosol containers, unfortunately, are occasionally not activated by shipping personnel.

There are advantages to treating a box, or other small package or container, on an interior surface before such box is filled with ware potatoes or other crops or produce which may be advantageously affected by 1,4 DMN or other crop preservative formulation. After 1,4 DMN is applied to an interior surface of such box and it is filled with potatoes and the box is sealed, an atmosphere exists therein which is eventually permeated by 1,4 DMN vapor. Such enclosed, or substantially enclosed, container provides an intimate environment between 1,4DMN vapor and the boxed potatoes other crops or produce during shipment to grocery stores and during the period such boxes or other containers are on the grocery shelves or in a consumer's home. Such treating in a packing plant eliminates the need for shipping personnel to have any role in preserving the treated crop during shipment.

Ware potatoes are those potatoes intended for immediate consumption as such by consumers in the form of baked potatoes, boiled potatoes or other potato dishes prepared in homes, restaurants and the like. Ware potatoes desirably are in a non-sprouting condition and contain no CIPC. 1,4 DMN is a natural product found in freshly harvested potatoes.

Pure 1,4 DMN is relatively expensive as a chemical, but it is a very effective sprout inhibitor/dormancy enhancer especially when applied to potatoes when first introduced into a storage unit. See U.S. Pat. No. 6,010,728 of Forsythe, et al. It can readily be applied to storage units as an aerosol, which forms a vapor, which is adsorbed by the stored potatoes. In contrast to CIPC, a well-known sprout inhibitor, which is deposited on bulk potatoes in a storage facility as minute solid particles derived from an aerosol.

1,4 DMN acts as a hormonal agent, prolonging dormancy, which is in contrast to most chemicals approved for potato sprout inhibition. Treatment of storage facilities typically involves such DMN being introduced at a concentration of about 2.0 micrograms per kg of stored potatoes; i.e., providing a theoretical “residue” of about 2 ppm.

In the treatment of small boxes, e.g., 50 lbs or less, filled with ware potatoes, the total quantity of DMN applied at a similar concentration to that applied to storage units would involve a very small amount. For example, to achieve a vapor concentration of 2 micrograms/kg for a 50 lb. box of potatoes (about 22 kg) would require about 50 micrograms. Given that a liter (1000 ml) of DMN, similar in density to water, weighs about one kilogram, one milliliter therefore equals approximately one gram. The liquid quantity to treat a 50 lb. box would be about 0.05 ml, or 1/20^{th} of a milliliter (about 50 microliters), a very small amount indeed.

Accurate deposition of such a minute amount of liquid chemical may be difficult to achieve. However, if a suitable solvent and/or compatible diluent is included at a ratio of 2:1 to about 50:1 (solvent/diluent ratio to DMN) then the liquid volume involved is increased such that more accurate deposition of small amounts of DMN, the active ingredient, is more readily achievable.

In the ejection system disclosed in the above-referenced co-pending application involving metering valves or pumps, a lubricant also may be advantageously included in a very minor amount. A diluent or solvent may be useful in conjunction with a compatible lubricant.

Lower alkyl naphthalenes, such as 1,4 DMN and related isomers, are known solvents. Thus, in an injection system the inclusion of a suitable quantity of lubricant in the liquid treatment composition may be advantageous to preclude frictional wear upon moving parts of the injection devices.

Other techniques for applying an effective small quantity of active ingredient, i.e., DMN, may include rollers, stamps, ink jet printers and the like. Such techniques may apply significant quantities of a liquid chemical composition, but relatively accurately apply only a small quantity of DMN, the active ingredient, especially when such active ingredient is a small fraction of the total liquid composition.

Suitable diluents include lower alcohols, which have been used as solvents for CIPC, e.g., methanol and isopropyl alcohol. Such alcohols are inexpensive compared with DMN and are relatively odorless. Also, given their volatility, similar to that of DMN, by the time such ware potatoes are consumed, any such adsorbed or absorbed alcohol will have evaporated from the skin of the potatoes. Other useful diluents may include ethanol, hexanol, octanol, nonanol, decanol and dodecanol, and the like. Most alcohols have some sprout inhibition characteristics. Various essential oils may also be included because of their volatility and sprout inhibition character. Many of the essential oils have a strong persistent odor, e.g., clove oil, which may be undesirable to consumers. Preferable essential oils include limonene, citronellol, citral and orgenol. Diluents, depending upon their type, and/or aroma characteristics may be used in varying amounts.

Deodorized DMN compositions such as those disclosed and claimed in U.S. Pat. No. 6,403,526 may be utilized with DMN alone or in combination with suitable diluents and lubricants as descried herein.

Given that the formulations described herein are designed to treat crops, especially potatoes, on their way to market, the addition of agreeable aroma providing chemicals may be desirable. Certain volatile chemicals have been discovered which provide an aroma of baked potatoes. Certain chemicals such as 2-ethyl-3,5-dimethyl pyrazine and other alkylated pyrazines are useful for such purposes as well as methional, 2,4-decadianol and other volatile organic compounds identified in Butters et al, Volatile Components of Baked Potatoes, 1973, 24, 1125-1131.

Any diluents or aroma-inducing or odor-negating liquid chemicals are preferably volatile so that no substantial residue of any chemical remains on a container when it is to be disposed of or recycled.

### DETAILED DESCRIPTION OF THE INVENTION

A volatile liquid crop-preservative composition adapted and formulated for application through at least one minute orifice comprising a volatile, active ingredient, liquid crop-preservative chemical effective in its vapor-phase; a liquid lubricant optionally present in a minor quantity wherein said lubricant is physically and chemically compatible with said crop-preservative chemical; a compatible liquid diluent present in an amount by volume of from zero to about 60%; and an aroma-providing or negating ingredient present in an amount by volume from zero to about 10% is effective for preservation of crops and produce in transit to grocers and the ultimate consumer.

Mixtures of various alkyl naphthalenes containing a significant quantity of substituted naphthalenes known to have tuber sprout inhibiting properties are useful in the instant invention especially if such mixtures are in liquid form. A solvent mixture of alkyl substituted naphthalenes having sufficient sprout inhibiting capabilities present, such as 1,4 DMN and DIPN (diisopropyl naphthalene) is useful for the purposes of this invention.

Mixtures of alkyl naphthalenes or 1,4 DMN itself are solvents. Thus, the addition of a liquid food-grade lubricant may be advantageous when use of such formulation is to be applied to a substrate through a metering valve or pump. Such lubricants may include Castor oil, canola oil, olive oil, alkyl oleate and other food grade oils. Oils, which are less likely to turn rancid are preferred. If rancidity is a concern, small amounts of antioxidants such as vitamin E may be included in the oils.

While DMN, especially 1,4 DMN, for example, is a very effective dormancy enhancer for tubers, mixtures of it with volatile essential oils may be very advantageous from an efficacy and economy standpoint. Many essential oils have good tuber sprout inhibiting properties and are less expensive than DMN, especially 1,4 DMN which has proven to be the best substituted naphthalene for treating stored potatoes to minimize sprouting and has been in commercial use for about a decade and is the only methyl naphthalene having an EPA registration.

Certain volatile essential oils, which may be used include clove oil, (eugenol), peppermint oil, carvacrol, limonene, citronellol, citral, orgenol and similar oils. Many of these, such as clove oil, have a strong odor and would not generally be preferred in treating boxes of crops such as ware potatoes headed for prompt home usage.

DMN was shown to be effective on sprouting root and tuber crops, including but not limited to, beet, carrot, cassava, dasheen (taro), ginger, ginseng, horseradish, parsnip, pototato, sweet potato, turnip, and yam. DMN was also shown to be effective on sprouting bulb crops, including but not limited to, garlic, leek, onion, and shallot. DMN was also shown to be effective on sprouting ornamentals, such as flowering bulbs.

The various 1,4 DMN based formulations disclosed herein may be useful in the preservation of crops such as berries, especially raspberries, blackberries, and strawberries during shipment to market. Treatments of berries with predetermined dosages of 1,4 DMN have generally aided in maintenance of hydration, color and general health. Strawberries and other crops as well are often contaminated with a fungus or mold even after washing. Such fungi or mold often blooms after the strawberries reach a consumer, thereby shortening their useful life. Treatment of such crops with the disclosed 1,4 DMN formulation tends to kill or diminish the presence of such fungi and molds.

While only 1,4 DMN is currently approved as a sprout inhibitor for potatoes, other dimethyl naphthalenes such as 1,2 DMN and 1,6 DMN show some effectiveness as sprout inhibitors. Given the volatility of all DMN isomers, it is not anticipated that any such DMN adsorbed or absorbed onto or into a potato during the small amounts existing as vapor during shipment would remain with the potatoes very long after being removed from a treated container. Thus, it is within the scope of the instant invention that mixtures of DMN isomers could be utilized and even mixtures of lower alkyl naphthalenes generally. Diiosopropyl naphthalene has also been approved as a potato sprout inhibitor; however, its effectiveness appears to be much less than 1,4 DMN and has been utilized commercially in much smaller quantities. It is generally much less volatile; however, the formulation of this invention may include various diisopropyl naphthalene isomers.

As indicated herein 1,4 DMN is a principal component of the novel formulations of the instant invention. It is an active chemical, providing sprout inhibition and hydration for potatoes. Besides diluents, etc. other active ingredients may be included in the formulations. For example, 2-nonanone has been identified as a mold retardant for fresh berries (see U.S. Pat. No. 5,334,619). This chemical is relatively volatile so that it could be compatively included in a 1,4 formulation used to treat berries, for example, either in a closed room or in containers during shipment to market.

It has been shown that 1,4 DMN provides extended hydration to treated fresh berries (see U.S. patent application Ser. No. ______, Attorney Docket No. 1957-10340US filed contemporaneously herewith and incorporated by reference and entitled “FRUIT SHELF-LIFE EXTENSION”).

Other active chemicals in the unique compositions of the instant invention may include higher alcohols, such as C₆-C₁₀, aliphatic alcohols, having a volatility similar to that of 1,4 DMN. Higher alcohols such as nonanol were shown by Burton, namely, a trimethyl hexanol, to be very effective sprout desiccators for potatoes, i.e., “burner” of nascent sprouts.

The action of nonanol, however, was so aggressive that it damaged potato flesh near the eyes. Knowles (U.S. Pat. No. 6,855,669) observed a similar damaging effect with certain unsaturated aliphatic aldehydes and ketones (see Ex 4, col 11, lines 50 et seq. wherein “pitting” was reported).

What has recently been discovered is that inclusion of a C₆-C₁₀ alcohol, for example, with 1,4 DMN blackens any white “peeps” and nascent sprouts without any attendant damage to potato flesh near the eyes.

The C₆-C₁₀ alcohols have a volatility similar to that of 1,4 DMN so a mixture thereof may compatibly be effectively fogged or applied to a container as a liquid with the vapors thereof providing an efficacious result. Especially useful are such alcohols as 1-nonanol, 1-hexanol, 1-octanol and 1-decanol, the latter being solid at room temperatures, but highly soluble in 1,4 DMN.

Other useful active chemicals may include lower alkyl esters of C₆-C₁₀ aliphatic alcohols, such as methyl, ethyl or propyl esters of 1-nonanol or 1-hexanol. Mixtures of these with 1,4 DMN have also provided surprisingly good results in achieving sprout inhibition of potatoes, especially ware potatoes, while maintaining a desirable degree of hydration.

Other volatile chemicals include aliphatic aldehydes and ketones, including those disclosed in Knowles, U.S. Pat. No. 6,855,669. Useful essential oils are described in Vaughn U.S. Pat. Nos. 5,139,562, 5,129,951 as well Winkelman U.S. Pat. No. 5,580,596 and Farooqi U.S. Pat. No. 6,313,073. Also U.S. Pat. No. 5,334,619 to Vaughn discloses 2-nonanone as a useful fungicide for treatment of berries. These chemicals typically have a volatility in about the same range as 1,4 DMN, for example, and may be utilized in conjunction with 1,4 DMN, either in a compatible mixture or in sequence with 1,4 DMN. The above-identified volatile chemicals may also be used separately from 1,4 DMN, when as separate active ingredients or in admixtures of such chemicals with solvents, diluents and the like.

Given that the unique formulations described herein are uniquely composed to provide a volatile active ingredient upon a packaged commodity, it may be useful to incorporate a dye or pigment in such formulation to enable affixation of a logo or message on said package. The volatile active ingredients described herein such as 1,4 DMN and volatile alcohols are effective solvents, thus, the inclusion of soluble dyes therein provide an ink which has crop-preserving properties. Such inks may be applied to a crop or produce-containing package by ink jet printers, for example, to inscribe text or logos thereon. Various ink formulations which may be incorporated in the unique compositions of the instant invention include those described in U.S. Pat. No. 7,393,400 and 4,168,662.

The volatile liquid formulations described and claimed herein, especially those including 1,4 DMN, may be used to treat a wide variety of crops and produce during the filling of various types of packages, boxes, cartons, etc. in preparation for distribution to grocers.

1. A liquid crop-preservative composition adapted and formulated for application through a minute opening comprising:
a volatile, active ingredient, liquid crop-preservative chemical effective in its vapor-phase;
a compatible liquid diluent and/or additional active ingredient present in an amount by volume of from zero to about 60%; and an aroma-providing or odor-negating ingredient present in an amount by volume from zero to about 10%.

2. The liquid-crop preservative composition of claim 1, wherein said liquid-crop preservative chemical is a dimethyl naphthalene.

3. The liquid-crop preservative composition of claim 1, wherein said liquid-crop preservative chemical is an aromatic essential oil.

4. The liquid-crop preservative composition of claim 1, wherein said liquid-crop preservative chemical is CIPC in an organic solvent or in a water based emulsion.

5. The liquid-crop preservative composition of claim 1, wherein a lubricant is included which is an organic, non-oxidizing, essentially non-polar long chain hydrocarbon compatible with said crop preservative chemical.

6. The liquid crop preservative composition of claim 1, wherein said active ingredient has a substantial vapor pressure at low temperatures.

7. The liquid crop-preservative composition of claim 1, wherein said volatile active ingredient is effective in the vapor-phase to provide a crop-preservative effect.

8. The liquid crop-preservative composition of claim 1, present in an effective quantity upon at least one surface of a container sized and adapted to contain a predetermined quantity of a crop to be preserved.

9. The liquid crop-preservative composition of claim 1, wherein said volatile active ingredient is 1,4 DMN.

10. A low-viscosity DMN-containing composition for effectively treating tubers comprising:
1,4 dimethyl naphthalene; and
a compatible organic diluent present in at least a minor quantity.

11. The composition of claim 10, wherein a lubricant is included which is an essential oil.

12. The composition of claim 10, wherein the diluent is a food grade organic compound.

13. The composition of claim 10, wherein the diluent is a lower chain alcohol.

14. The composition of claim 10, wherein the quantity of 1,4 DMN in said composition is sufficient to be effective in the vapor-phase as a crop-preservative.

15. The composition of claim 10, wherein additional lower alkyl naphthalenes are present.

16. The composition of claim 1, wherein said preservative chemical is a C₆-C₁₀ aliphatic alcohol.

17. The composition of claim 2, wherein an additional preservative chemical is a C₆-C₁₀ aliphatic alcohol, ketone or aldehyde.

18. The composition of claim 2, wherein an additional preservative chemical is 2-nonanone.

19. The composition of claim 1, wherein said preservative chemical is a lower alkyl ester of a C₆-C₁₀ aliphatic alcohol.

20. The composition of claim 2, wherein an additional preservative chemical is a lower alkyl ester of a C₆-C₁₀ aliphatic alcohol.
